(19) United States
(12) Patent Application Publication
(10) Pub. No.: US 2016/0160635 A1
(43) Pub. Date: Jun. 9, 2016

(54) MEASUREMENT DEVICE

(71) Applicant: IKM PRODUCTION TECHNOLOGY AS, Sola (NO)

(72) Inventors: Anders LANGSETH, Sola (NO); Pål A. MATRE, Sola (NO)

(21) Appl. No.: 14/906,245

(22) PCT Filed: Jul. 22, 2014
(86) PCT No.: PCT/NO2014/050132

§ 371 Date: Jan. 19, 2016

(30) Foreign Application Priority Data
Jul. 24, 2013 (GB) GB1313181.8
Jul. 24, 2013 (NO) 20131033

(51) Int. Cl. E21B 47/10; G01M 3/28

(52) U.S. Cl. CPC E21B 47/1025; G01M 3/2815

(57) ABSTRACT

A system and a method for investigating and quantifying leakage rate of a fluid in an annulus are provided. An objective of the present invention is to provide an improved system and method for investigating and quantifying leakage rate of a fluid in an annulus. The present invention attains the above-described objective by the use of a throttle valve for setting a constant cross section opening while operating in choked flow and registering mass flow and change in pressure.

### BACKGROUND OF THE INVENTION

1. Technical Field

The invention relates to leak rate measurements in general and more specifically a system and a method for investigating and quantifying leakage rate of a fluid in an annulus.

2. Background Art

From prior art one should refer to Xu, Rong. (2002). ANALYSIS OF DIAGNOSTIC TESTING OF SUSTAINED CASING PRESSURE IN WELLS (Ph.D. Dissertation, Louisiana State University and Agriculture and Mechanical College). This document describes properties of SCP (Sustained Casing Pressure) in wells, particularly in respect to gas pressure build-up.

References should also be made to SPE 117961: Ali Al-Tamimi et al (2008). Design and fabrication of a Low rate metering Skid to Measure Internal Leak Rates of Pressurized Annuli for Determining Well Integrity Status.

This approach suffers from the need to bleed pressure down to zero or as low as reasonably achievable pressure.

One should also refer to NO20092445, granted as NO331633 and published as WO/2010/151144, relating to a method and an apparatus to investigate and quantify a leakage rate for a fluid between a first pipe and a second pipe, the first pipe being surrounded by at least a portion of the second pipe, where the pipes are arranged in a well in a ground and where a measuring arrangement including a flow meter and a pressure meter is put into fluid communication with an annulus defined by the first pipe and the second pipe, where fluid in the gaseous phase is conveyed through the measuring arrangement, as the annulus is used as a separation chamber for gas and liquid.

NO20092445 discloses a need for separation of gas and liquid wherein this is achieved using an annulus as a separation chamber, thus eliminating the need for a dedicated separation container in the measurement system. Yet, having supposedly eliminated the need for a dedicated separation container the document still discloses the possibility for gas condensing in the measurement system and precipitating as a liquid due to e.g. temperature drop. This is compensated using heated piping. Tests show that condensation does take place and that heating of the piping is not a simpler or more adequate solution than a dedicated separation container in the measurement system.

From prior art one should furthermore refer to

G82483823 relating to leaks in flexible tubing,

US2011/0247432 relating to mass flow in aircrafts, and

US 2007/0051511 relating to breach detection in petroleum wells.

The fluid from the reservoir comprises oil, gas and water on entering a separator and will be mixed due to the fast and turbulent flow conditions in the tubing. In the separator the flow rate will be strongly reduced and thus also the turbulent forces so that gravitational forces will allow oil, water and gas to be separated. The speed of separation of water from oil will be determined by the speed water falls through the oil. The effectiveness of an annulus as a separation chamber will therefore be dependent on the separation process being given sufficient time before fluid is extracted from the annulus to further processing upstream.

Foaming is a problem and the entire liquid column can be filled with foam once the annulus is bled down and thus occupy a much larger volume than purely “inert” fluid. An echometer will register the top surface of the foam phase and thus yield incorrect information as to how much fluid has flowed in.

### DISCLOSURE OF THE INVENTION

### Problems to be Solved by the Invention

A main objective of the present invention is to provide an improved system and method for investigating and quantifying leakage rate of a fluid in an annulus.

It has also been realised that the need to bleed pressure down to low pressures, approaching atmospheric pressures, results in a large pressure difference between an annulus and the tubing. Since the tubing and the annuli are long this means a large force arises that can impact the integrity of the structure and increase a leak or even rupture a wall. The inventor has therefore realised the need for an approach that does not involve a large pressure differential.

It has also been realised that prior art is based on a steady state while using a valve to maintain constant pressure differential. These two aspects are not possible to combine and thus the criteria for true steady state are not really present. With an erroneous premise the method cannot be valid and there is a contradiction in terms.

Also the annulus itself represents a large volume and is capable of storing and unloading fluids. The volume can be about 30 m³. Volume varies and there are known cases of volumes up to 130 m³. This means that the flow rate measured at surface may not necessarily equal the flow rate through a leakage point deep down in the annulus. When an annulus is first opened to flow the initial production at surface may come entirely from fluids unloaded from the annulus bore and it may be a considerable time before the surface flow rate equals the leakage point flow rate. The term “considerable time” implies longer than one can normally allow the test to last.

When an annulus is shut in at surface fluids may continue to flow through the leakage point into the annulus for equally considerable time as the annulus stores fluid—a process commonly known as afterflow.

These effects are essentially due to the same phenomenon, and are collectively referred to within well test interpretation literature as wellbore storage effects.

If a test is completely dominated by annulus storage then that data will be useless as a source for leakage analysis. Annulus storage effects must therefore be considered in the design and analysis of an annulus leak test.

Based on this premise the inventors have discovered a need to find valid methods not requiring large pressure differentials for

A: determining if a leak into an annulus is through cement or tubing,
B: determining leak rate into annulus through cement, and
C: determining leak rate into annulus from tubing or annulus to annulus

### The Primary Need for the Invention

An operator (an oil company) of an oil/gas well has the duty of performing planned maintenance in order to verify that all barrier elements of the well perform according to purpose. This comprises leak testing of valves installed at certain depths in a well for the purpose of leading gas from the A-annulus and into the tubing to ensure that oil flows from the reservoir to the surface. Such valves are known as GLV (Gas Lift Valves). Such valves are to be closed when there is no pressure difference between the A-annulus and tubing, or there is a higher pressure in the tubing than in the A-annulus. A closed valve has to be seal closed. There will nevertheless be a certain probability for a leak. One reason for this is that tubing and casings are pressure tested using liquid where a minor leak might not be noticed. Later this can arise once the site of the leak is exposed to a differential gas pressure.

### Means for Solving the Problems

The objective is achieved according to the invention by

a method for investigating and quantifying leakage rate of a fluid in an annulus as defined in the preamble of claim 1, having the features of the characterising portion of claim 1,

a method for investigating and quantifying leakage rate of a fluid in an annulus as defined in the preamble of claim 2, having the features of the characterising portion of claim 2, and

an apparatus for investigating and quantifying leakage rate of a fluid in an annulus as defined in the preamble of claim 8, having the features of the characterising portion of claim 8.

The present invention attains the above-described objective by the use of a throttle valve for setting a constant cross section opening while operating in choked flow and registering mass flow and change in pressure.

In a first aspect a method for investigating and quantifying leakage rate of a fluid in an annulus between a first pipe and a second pipe, wherein the first pipe, being surrounded by the second pipe, is provided wherein the method comprises:

a: bleeding fluid in the gas phase from the second pipe through a first throttle valve to a first mass rate, while operating in choked flow

b: registering pressure and mass rate response through a first throttle valve over a predetermined period of time,

c: determine mass rate (Q) and change in pressure (dp/dt)

repeating steps a-c to obtain at least one more reading.

In a second aspect a method for investigating and quantifying leakage rate of a fluid in an annulus between a first pipe and a second pipe, wherein the first pipe, being surrounded by the second pipe, is provided, wherein the method comprises:

x: closing throttle valve,

y: measure a resulting pressure build up (dp/dt) when Q=0,

It is preferred that the method of the second aspect is performed subsequent to performing the method according to first aspect.

In a preferred embodiment an external separation chamber that is integrated with the measurement apparatus is used.

### Effects of the Invention

The technical differences over prior art according to NO331633 is the use of an external separator which is integrated in the measurement apparatus. The technical effect of this is the ability to simultaneously and reliably determine the fluid flow of gas and the fluid flow of liquid, wherein the fluid phases are pure phases which is important to make mass flow of bled gas workable.

These effects provide in turn several further advantageous effects:

it makes it possible to avoid bleeding annulus pressure down to zero, which in turn leads to reduced stresses on the tubing and the environment,

it saves time since it takes a long time to bleed pressure to zero while the present invention requires less time to reach choked flow,

it is not necessary to assume the process is in a steady state.

It should also be pointed out that prior art is based on the assumption that flow through measurement system at the surface is the same as the flow through the leak. The weakness in the argument, that the present invention overcomes, is that there is a substantial distance between the two positions of critical flow at the leak and the measurements at the surface. Between these a large amount of gas is stored compared to the rate intended to measure.

### BRIEF DESCRIPTION OF THE DRAWINGS

The above and further features of the invention are set forth with particularity in the appended claims and together with advantages thereof will become clearer from consideration of the following detailed description of an exemplary embodiment of the invention given with reference to the accompanying drawings.

The invention will be further described below in connection with exemplary embodiments which are schematically shown in the drawings, wherein:

FIG. 1 shows a typical embodiment of the invention

FIG. 2 shows a plot of Q vs. dp/dt

FIG. 3 shows a plot of P and Q vs. t

FIG. 4 shows an embodiment of a separator

### DESCRIPTION OF THE REFERENCE SIGNS

The following reference numbers and signs refer to the drawings:

| | |
|---|---|
| 1 | Well |
| 3 | Tubing |
| 5 | First casing |
| 7 | Second casing |
| 9 | Third casing |
| 11 | Sealing medium, production packer |
| 12 | Leak hole (unintentional) |
| 13 | Cement |
| 20 | Measuring arrangement - fluid flow |
| 22 | Fluid communication line comprising a tube |
| 23 | First flow meter (coriolis) for gas flow |
| 24 | Second flow meter (coriolis) for liquid |
| 25 | First pressure sensor |
| 25′ | First pressure gauge (readout, recording of data via logging system) |
| 26 | Second pressure sensor |
| 26′ | Second pressure gauge (readout, recording of data via logging |
| | system) |
| 27 | Signal cable between pressure sensor and pressure gauge |
| | (Alternatively wireless communication) |
| 28 | First throttle valve - gas flow control |
| 29 | Second throttle valve - liquid flow control |
| 30 | Measuring arrangement - acoustic liquid level |
| 31 | Acoustic signal analyser unit (Echometer) |
| 33 | Acoustic signal communication cable (Echometer) |
| 35 | Acoustic source (Echometer) |
| A | A-annulus |
| B | B-annulus |
| C | C-annulus |
| FG | Free gas |
| FL | Liquid |
| LL | Liquid surface (Liquid level) |
| LL_{A} | Liquid surface (Liquid level) in A-annulus |
| LL_{B} | Liquid surface (Liquid level) in B-annulus |
| 40 | Separation chamber |
| 41 | Separator temperature sensor |
| 43 | Separator pressure sensor |

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

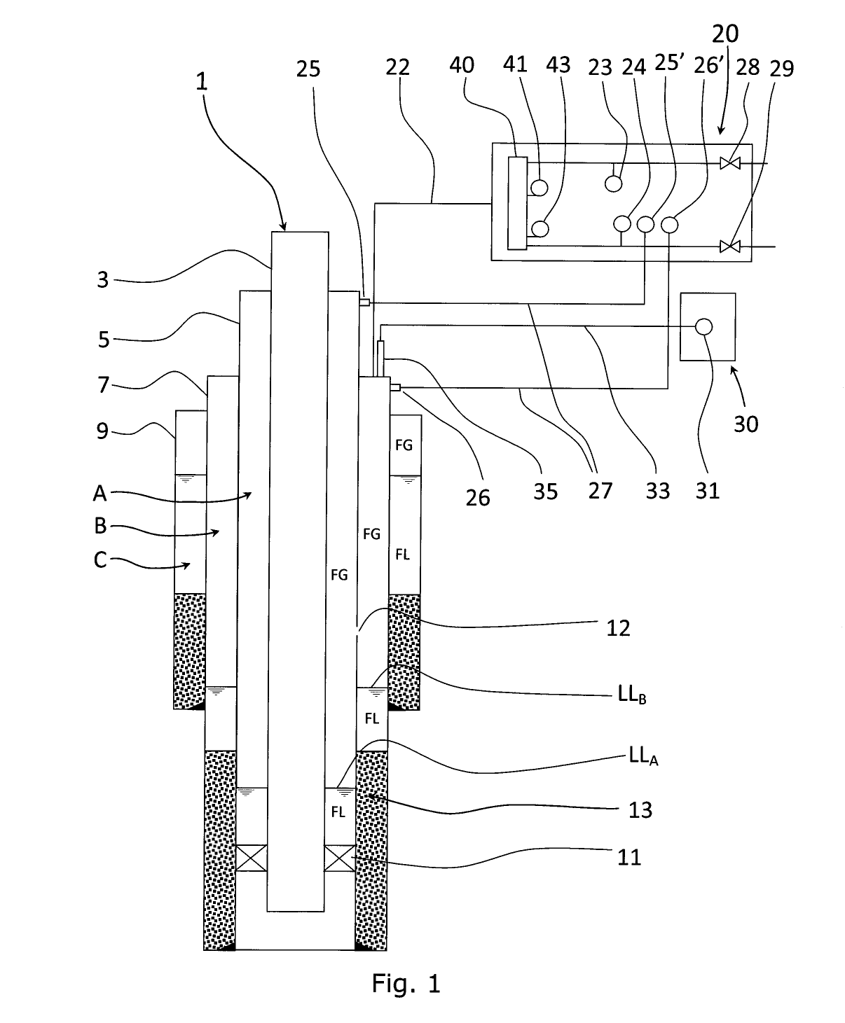

The invention will be further described in connection with exemplary embodiments which are schematically shown in the drawings, wherein FIG. 1 shows typical embodiment of the invention as well as the well and related devices such as casings.

### Principles Forming the Basis of the Invention

The inventors have found that when using a throttle valve rather than a constant pressure difference valve the system can be modelled as a pressure reservoir, corresponding to the tubing, connected to a tank having a certain volume, corresponding to the annulus. Fluid under pressure flows from the pressure reservoir through a throttled connection between the pressure reservoir and the tank, wherein the throttled connection represents the leak. The tank is also connected to an outlet which is the apparatus according to the invention, having a throttle valve and means for measuring the mass flow.

The underlying principle of the invention is to determine the leak rate Qₗₑₐₖ by determining a mass flow rate Q for a corresponding rate change in pressure dp/dt when operating in a choked flow. The data points can be fitted to a straight line that intersects the Y-axis representing the leak rate Q through the leak 12 shown in FIG. 1 at dp/dt=0.

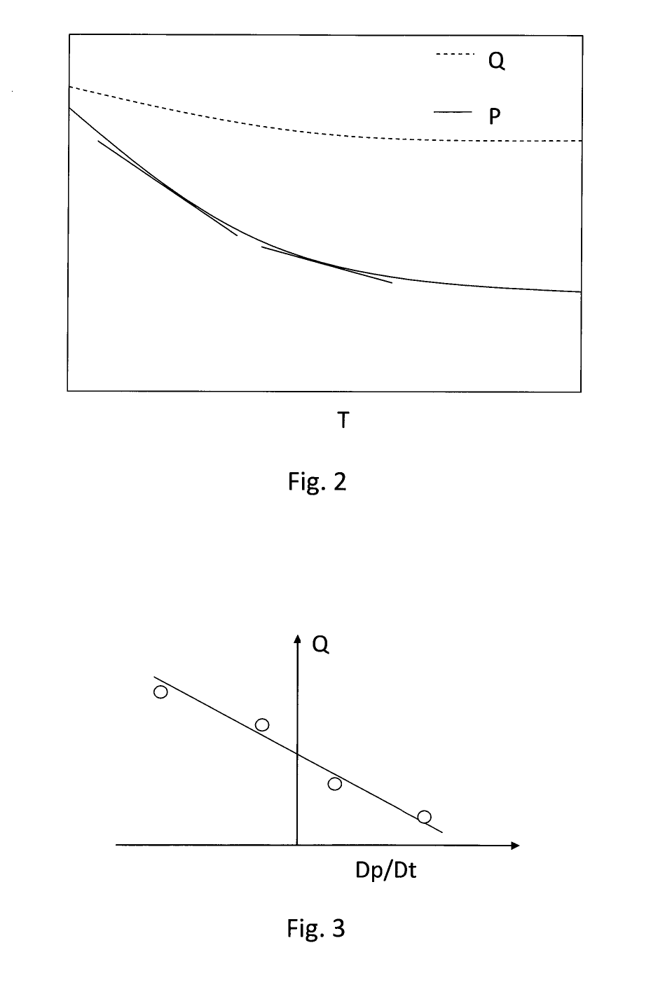

FIG. 2 shows such a plot.

It will be appreciated that it is necessary with at least 2 data points to plot the line that gives the intercept. Nevertheless it is good practice to measure further data points to make sure that the system operates in the expected choked flow rate and to allow for second order terms of higher to allow for a non-perfect gas. Significant divergences from the expected behaviour indicate deviations from the basic assumptions, for instance that the leak rate is changing significantly over the time period of measuring the data points.

With this in mind it has been realised that the reduction to practice will result in two substantially different measurement methods that still are embodiments of the same inventive concept.

In a first embodiment the pressure p is reduced over time t by bleeding the pressure through a throttle valve until entering choked mass flow and then measuring a plurality of data points Q for a corresponding value of dp/dt.

In a second embodiment the pressure p is increased over time by closing the throttle valve, measuring the pressure buildup when Q=0, calculating Dp/Dt for Q=0.

The calculation to determine Qₗₑₐₖ from the acquired data points can be made in several ways. In a first embodiment of the calculation the Qₗₑₐₖ is represented by Q at dp/dt=0, determined by finding the intercept of the Y-axis representing values of Q where the X-axis represents values of dp/dt. In a second embodiment of the calculation the value of Qₗₑₐₖ determined as the asymptotic approach of Q.

FIG. 3 shows a plot of Q vs. time t.

This method will uncover the leak rate with a significantly higher reliability and accuracy than is obtained in the prior art.

### BEST MODES OF CARRYING OUT THE INVENTION

The embodiment of the apparatus according to the invention shown in FIG. 1 comprises 3 annuli A, B and C separated by tubing 3 and casings 5, 7 and 9, in such a way that A-annulus is between casings 3 and 5 and B-annulus is between casings 5 and 7 and C-annulus is between casings 7 and 9.

All casings are sealed at the bottom using sealing medium 11 or cement 13.

In the embodiments shown the B-annulus is fluid connected to measuring arrangement 20 using a line 22 comprising a tube leading the fluid from the annulus to the measuring arrangement. Signal cables 27 are connected to first pressure sensor 25 attached to A-annulus, and a second pressure sensor 26 attached to B-annulus. These are connected to corresponding pressure gauges 25′ and 26′ and operable to measuring pressure of A- and B-annulus respectively. Additionally downstream of the measuring arrangement there are provided a throttle valve 28 for gas flow and a throttle valve 29 for liquid flow out of separator.

The figure shows a leak hole 12 formed in a part of the first casing 5 above liquid level LL_{A}. The hole is undesired and causes fluid flowing from the A-annulus to the B-annulus due to the pressure difference between the two. A liquid level LL_{B} of a liquid FL in the B-annulus forms a separation between liquid FL and gas FG.

A part of the gas flowing through the measurement arrangement may condense. The condensation depends on pressure and temperature conditions in the annuli and the PVT characteristics of the fluid. The measurement arrangement is provided with a separation chamber for gas and liquid so that only gas is led through Coriolis mass measurement unit 23. Thus it is not required to use an annulus as a separation chamber.

Using throttle valve 28 the throttle cross section can be maintained constant while measuring the pressure in the B-annulus and the gas rate Q through the measurement arrangement. It is assumed that the pressure downstream of the leak is less than or equal to half the pressure upstream of the leak, so called critical flow.

Thus the leak rate Q in terms of mass per unit time of fluid through the leak 12 will be constant. It should be noted that Q represents the mass rate of gas, nevertheless the use of a separator allows for some liquid in the mass flow.

In FIG. 1 the fluid is a gas. By determining dp/dt at different rates Q one can plot values of Q as a function of dp/dt. The points can be fitted to a straight line that intersects the Y-axis representing the leak rate through the leak 12 at dp/dt=0.

This method will uncover the leak rate with a significantly higher reliability and accuracy than is obtained in the prior art.

It is preferred that the properties of the gas are known. Having a single reading it is possible to determine volumetric gas leak rate at standard conditions. This can be determined by having the specific density of the gas as part of the calculations of a volumetric rate at standard conditions.

Also the measurement arrangement preferably comprises an acoustic measurement instrument 30 comprising a signal analyser 31 connected to acoustic source GUN 35 with cable 33 as shown in FIG. 1. Together this is referred to as an echometer, or EM.

The purpose of EM is to provide information regarding changes in the liquid level LL of the B-annulus. This can be used to discover changes in the mutual relationship between gas and liquid in the B-annulus and thus also any liquid leakage through the leak 12.

Liquid FL flows through the leak 12 from A to B due to the pressure difference between the two. The pressure difference can also cause some of the liquid to enter the gas phase in the B-annulus.

Using the throttle valve 28 the throttle cross section can be maintained at a constant level or opening while measuring the pressure in the B-annulus and the gas rate Q through the measurement apparatus. The gas leak rate can be determined as described above. Moreover the liquid leak rate can simultaneously be measured using EM.

### Alternative Embodiments

A number of variations on the above can be envisaged. For instance a need can arise to determine the liquid level in the separator. In a first embodiment the liquid level can be determined by an echo sounder or echometer.

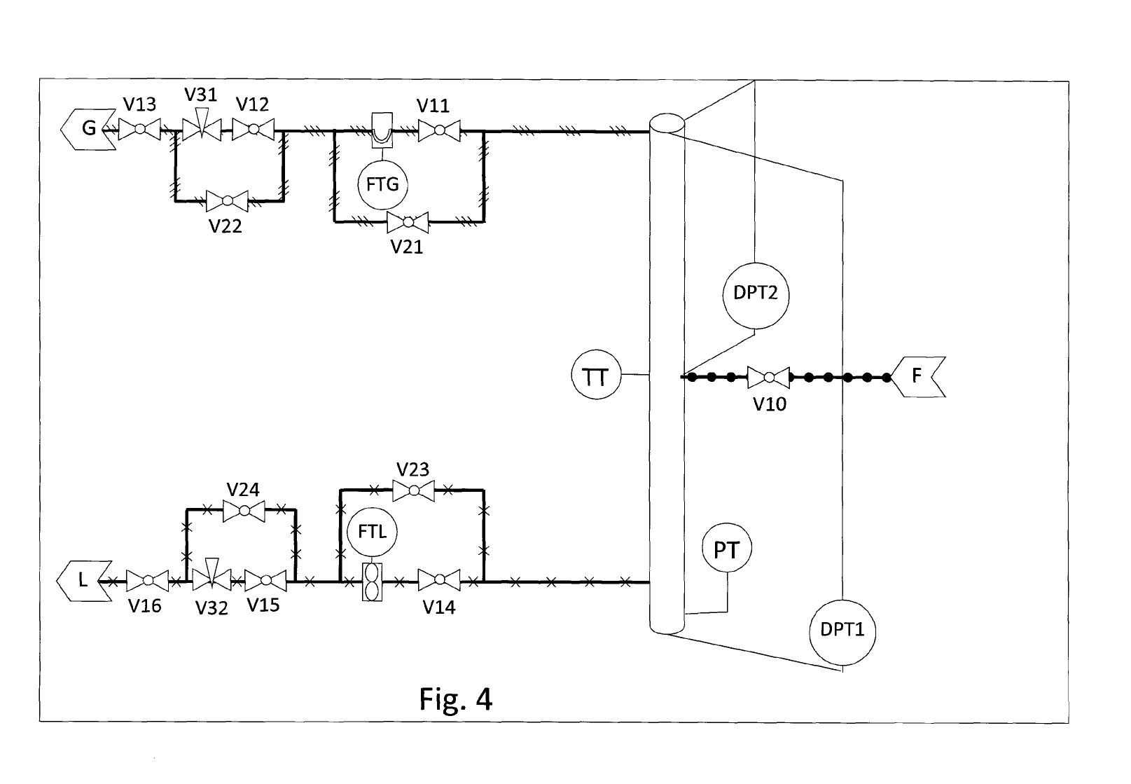

In a second embodiment, shown in FIG. 4, the liquid level is determined at specific intervals by the use of pressure gauges. Starting with a separator initially filled with gas and having a lower and an upper pressure gauge connected to the separator at a lower and an upper level respectively, the two pressure gauges read substantially the same pressure. As the separator is filled with liquid the liquid level increases until reaching the connector to the lower pressure gauge the lower gauge starts reading an increased pressure compared to that of the upper gauge. As the liquid level increases further also the upper connector is reached at which point the two pressure gauges read substantially the same difference in pressure. When the liquid is drained from the separator the readout process is correspondingly reversed.

### INDUSTRIAL APPLICABILITY

The invention according to the application finds use in determining leaking that relates to sustained casing pressure (SCP)

1. A method for investigating and quantifying leakage rate of a fluid in an annulus between a first pipe and a second pipe, the first pipe being surrounded by the second pipe,
the method comprising:
a: bleeding fluid in the gas phase from the second pipe through a first throttle valve to a first mass rate, while operating in choked flow;
b: registering pressure in the annulus and mass rate response through the first throttle valve over a predetermined period of time;
c: determining mass rate (Q) and change in pressure (dp/dt); and
repeating steps a-c to obtain at least one more reading.

2. A method for investigating and quantifying leakage rate of a fluid in an annulus between a first pipe and a second pipe, the first pipe being surrounded by the second pipe,
the method comprising:
x: closing the throttle valve,
y: measure a resulting pressure build up (dp/dt) in the annulus when Q=0.

3. The method according to claim 2, wherein the method is performed subsequent to performing the method comprising:
a: bleeding fluid in the gas phase from the second pipe through a first throttle valve to a first mass rate, while operating in choked flow;
b: registering pressure in the annulus and mass rate response through the first throttle valve over a predetermined period of time;
c: determining mass rate (Q) and change in pressure (dp/dt); and
repeating steps a-c to obtain at least one more reading.

4. The method for investigating and quantifying leakage rate of a fluid according to claim 1, wherein the leak rate is determined by:
determining rate response dp/dt for different mass rates Q;
curve fitting a line through a plot of mass rates Q along the Y-axis as a function of pressure response dp/dt; and
determining the intercept of said line at the Y-axis, wherein said intercept represents the leak rate for dp/dt=0.

5. The method for investigating and quantifying leakage rate of a fluid according to claim 1, wherein the leak rate is determined by
determining an asymptotic approach of the mass rate.

6. The method for investigating and quantifying leakage rate of a fluid according to claim 1, wherein the first pipe is A-annulus and the second pipe is B-annulus.

7. The method for investigating and quantifying leakage rate of a fluid according to claim 1, wherein the first pipe is tubing and the second pipe is A-annulus.

8. A system for investigating and quantifying leakage rate of a fluid in an annulus between a first pipe and a second pipe according to claim 1, the first pipe being surrounded by the second pipe, comprising:
a separation chamber to be able to separate the fluid into a gas phase (FG) and a liquid phase (FL),
a measuring arrangement being in fluid communication with the separation chamber, wherein the measuring arrangement comprises
a flow meter for gas,
two pressure gauges connected to two pressure sensors arranged to measure a pressure difference between either side of a leakage site, and
a valve arranged downstream of the measuring arrangement, and said valve is a throttle valve.

9. The method for investigating and quantifying leakage rate of a fluid according to claim 2, wherein the leak rate is determined by:
determining rate response dp/dt for different mass rates Q;
curve fitting a line through a plot of mass rates Q along the Y-axis as a function of pressure response dp/dt; and
determining the intercept of said line at the Y-axis, wherein said intercept represents the leak rate for dp/dt=0.

10. The method for investigating and quantifying leakage rate of a fluid according to claim 3, wherein the leak rate is determined by:
determining rate response dp/dt for different mass rates Q;
curve fitting a line through a plot of mass rates Q along the Y-axis as a function of pressure response dp/dt; and
determining the intercept of said line at the Y-axis, wherein said intercept represents the leak rate for dp/dt=0.

11. The method for investigating and quantifying leakage rate of a fluid according to claim 2, wherein the leak rate is determined by
determining an asymptotic approach of the mass rate.

12. The method for investigating and quantifying leakage rate of a fluid according to claim 3, wherein the leak rate is determined by
determining an asymptotic approach of the mass rate.

13. The method for investigating and quantifying leakage rate of a fluid according to claim 2, wherein the first pipe is A-annulus and the second pipe is B-annulus.

14. The method for investigating and quantifying leakage rate of a fluid according to claim 3, wherein the first pipe is A-annulus and the second pipe is B-annulus.

15. The method for investigating and quantifying leakage rate of a fluid according to claim 4, wherein the first pipe is A-annulus and the second pipe is B-annulus.

16. The method for investigating and quantifying leakage rate of a fluid according to claim 2, wherein the first pipe is tubing and the second pipe is A-annulus.

17. The method for investigating and quantifying leakage rate of a fluid according to claim 3, wherein the first pipe is tubing and the second pipe is A-annulus.

18. The method for investigating and quantifying leakage rate of a fluid according to claim 4, wherein the first pipe is tubing and the second pipe is A-annulus.

19. A system for investigating and quantifying leakage rate of a fluid in an annulus between a first pipe and a second pipe according to claim 2, the first pipe being surrounded by the second pipe, comprising:
a separation chamber to be able to separate the fluid into a gas phase (FG) and a liquid phase (FL),
a measuring arrangement being in fluid communication with the separation chamber, wherein the measuring arrangement comprises
a flow meter for gas,
two pressure gauges connected to two pressure sensors arranged to measure a pressure difference between either side of a leakage site, and
a valve arranged downstream of the measuring arrangement, and said valve is a throttle valve.
